(19) United States
(12) Patent Application Publication
(10) Pub. No.: US 2025/0122014 A1
(43) Pub. Date: Apr. 17, 2025

(54) Article Sorting Facility

(71) Applicant: Daifuku Co., Ltd., Osaka-shi (JP)

(72) Inventor: Kenichi Ukisu, Tokyo (JP)

(21) Appl. No.: 18/917,032

(22) Filed: Oct. 16, 2024

(30) Foreign Application Priority Data
Oct. 17, 2023 (JP) 2023-178852

(51) Int. Cl. B65G 1/04; B65G 1/137

(52) U.S. Cl. CPC B65G 1/0492; B65G 1/1375; B65G 2203/0283

(57) ABSTRACT

In an article sorting facility, a plurality of transport vehicles travel on a floor and transport articles to sort the articles. The floor includes an aisle area extending in a direction along the floor, a supply area including supply units, and a connection area connecting the aisle area to the supply area. A plurality of receivers are arranged along the aisle area. The floor includes, in an area other than the aisle area, a standby area for the plurality of transport vehicles to wait before entering the aisle area.

### CROSS-REFERENCE TO RELATED APPLICATION

This application claims priority to Japanese Patent Application No. 2023-178852 filed Oct. 17, 2023, the disclosure of which is hereby incorporated by reference in its entirety.

### BACKGROUND OF THE INVENTION

### Field of the Invention

The present invention relates to an article sorting facility in which multiple transport vehicles transport articles.

### Description of Related Art

Recent article sorting facilities such as distribution warehouses have automated article transport systems. For example, Japanese Unexamined Patent Application Publication No. 2020-100482 (JP 2020-100482) describes an article sorting facility in which transport vehicles (V) transport articles (W) from a supply unit (90) to receivers (80).

In the article sorting facility described in JP 2020-100482, when a transport vehicle (V) travels from the supply unit (90) to a receiver (80), and for example, when another transport vehicle (V) is stopped on a travel path for the transport vehicle (V) or when the receiver (80) that is a destination of an article (W) transported by the transport vehicle (V) cannot receive the article (W), the transport vehicle (V) is also to stop on the travel path. When many transport vehicles stop in such situations, the travel path is to be congested. However, JP 2020-100482 does not particularly describe any solution to such congestion.

### SUMMARY OF THE INVENTION

One or more aspects are directed to an article sorting facility in which congestion is less likely to occur.

An article sorting facility according to an aspect of the disclosure is an article sorting facility in which a plurality of transport vehicles travel on a floor and transport articles to sort the articles. The article sorting facility includes supply units that supply the articles to the plurality of transport vehicles, and a plurality of receivers that receive the articles from the plurality of transport vehicles. The floor includes an aisle area extending in a direction along the floor, a supply area including the supply units, and a connection area connecting the aisle area to the supply area. The plurality of receivers are arranged along the aisle area. The floor includes, in an area other than the aisle area, a standby area for the plurality of transport vehicles to wait before entering the aisle area.

This structure allows a transport vehicle to wait in the standby area without causing the transport vehicle to enter the aisle area in response to a receiver that is a destination of an article transported by the transport vehicle being in the non-receiving state in which the articles are unreceivable by the receiver. This reduces the likelihood that the aisle area is congested with transport vehicles waiting in the aisle area, which is a narrow area extending in the specific direction. This also reduces the likelihood that the transport vehicles are to travel on the aisle area multiple times while passing by receivers in the non-receiving state to avoid congestion in the aisle area. As described above, this structure reduces the likelihood of congestion with the transport vehicles.

### BRIEF DESCRIPTION OF THE DRAWINGS

The terms Fig., Figs., Figure, and Figures are used interchangeably in the specification to refer to the corresponding figures in the drawings.

FIG. 1 is a top view of an article sorting facility according to a first embodiment.

FIG. 2 is a front view of an aisle area in FIG. 1.

FIG. 3 is a control block diagram of the article sorting facility in FIG. 1.

FIG. 4 is a diagram of a first layer of a floor in FIG. 1.

FIG. 5 is a diagram of a second layer of the floor in FIG. 1.

FIG. 6 is a top view of an article sorting facility according to a second embodiment.

FIG. 7 is a front view of an aisle area in FIG. 6.

### DESCRIPTION OF THE INVENTION

An article sorting facility according to a first embodiment will be described below with reference to the drawings.

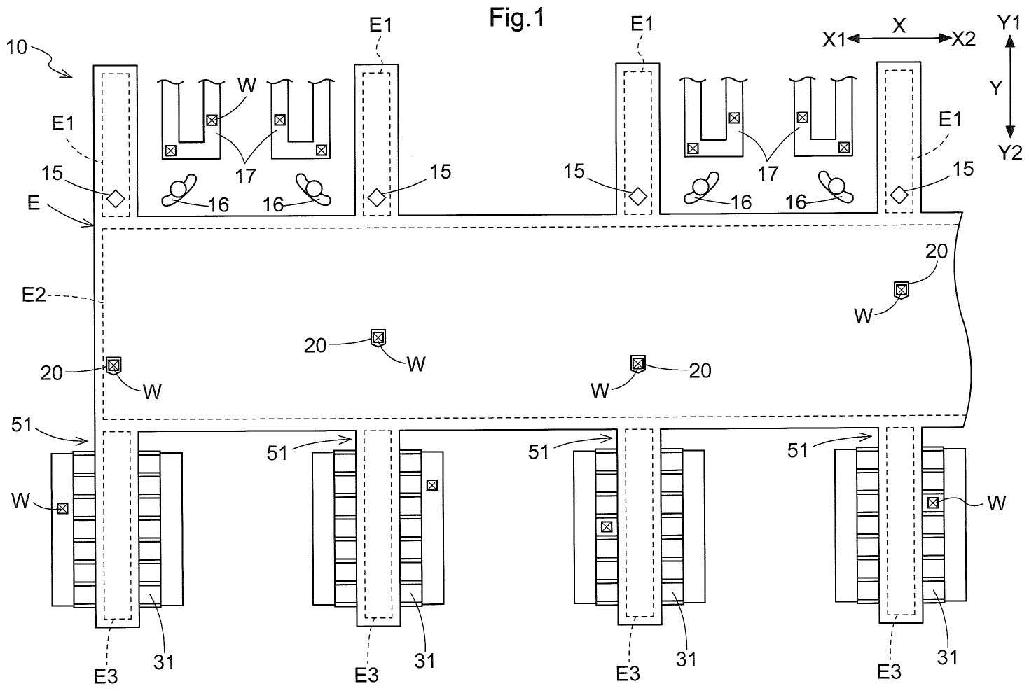

FIG. 1 is a top view of an article sorting facility 10 in which multiple transport vehicles 20 travel on a floor E and transport articles W to sort the articles W. The article sorting facility 10 includes the transport vehicles 20, the floor E, supply units 15 that supply the articles W to the transport vehicles 20, and multiple receivers 31. The multiple receivers 31 receive the articles W from the transport vehicles 20.

An operating entity 16 transfers articles W to transport vehicles 20 at each supply unit 15. The operating entity herein refers to, for example, an operator, an operating device, or both. The operating entity 16 transfers the articles W from a supply transporter 17 to the transport vehicles 20. The supply transporter 17 transports the articles W from an automated warehouse (not shown). Examples of the supply transporter 17 include a belt conveyor, a crane, and a robotic arm.

A specific direction along the floor E is herein referred to as a Y-direction. A direction along the floor E and perpendicular to the Y-direction is referred to as an X-direction. One side in the Y-direction is referred to as a first side Y1 in the Y-direction, and the other side in the Y-direction is referred to as a second side Y2 in the Y-direction. One side in the X-direction is referred to as a first side X1 in the X-direction, and the other side in the X-direction is referred to as a second side X2 in the X-direction. The vertical direction is referred to as a Z-direction. Examples of the floor E include travel surfaces on which vehicles travel and floors in buildings, ships, and other facilities. In the present embodiment, the floor E is a travel surface on an indoor platform.

The floor E includes supply areas E1 with the supply units 15 and aisle areas E3 extending in the Y-direction. The supply areas E1 are arranged on the first side Y1 in the Y-direction relative to the aisle areas E3. The multiple aisle areas E3 are arranged in the X-direction. The floor E includes a connection area E2 connecting the aisle areas E3 and the supply areas E1. The supply areas E1, the connection area E2, and the aisle areas E3 on the floor E may each be actually-divided areas or virtually-defined areas on the floor E. In the present embodiment, the boundaries between the supply areas E1 and the connection area E2 are virtual boundaries defined on the floor E. In the present embodiment, each aisle area E3 has its two ends in the X-direction that are the outer edges of the floor E.

The connection area E2 connects the supply areas E1 and the aisle areas E3 to allow the transport vehicles 20 to travel between the areas. The aisle areas E3 have first ends 51 on the first side Y1 in the Y-direction. The connection area E2 connects the first ends 51 of the aisle areas E3 and the supply areas E1.

The multiple aisle areas E3 are arranged in the X-direction on the floor E. The first ends 51 of the aisle areas E3 are connected to one another with the connection area E2 between them. The multiple receivers 31 are arranged along the aisle areas E3. The article sorting facility 10 includes the multiple supply units 15. The multiple supply areas E1 each including the supply unit 15 are arranged in the X-direction on the floor E.

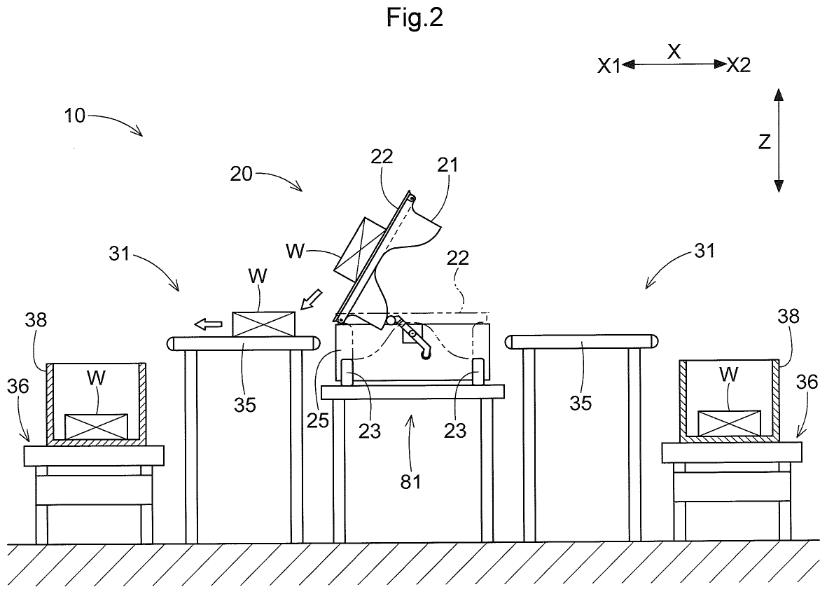

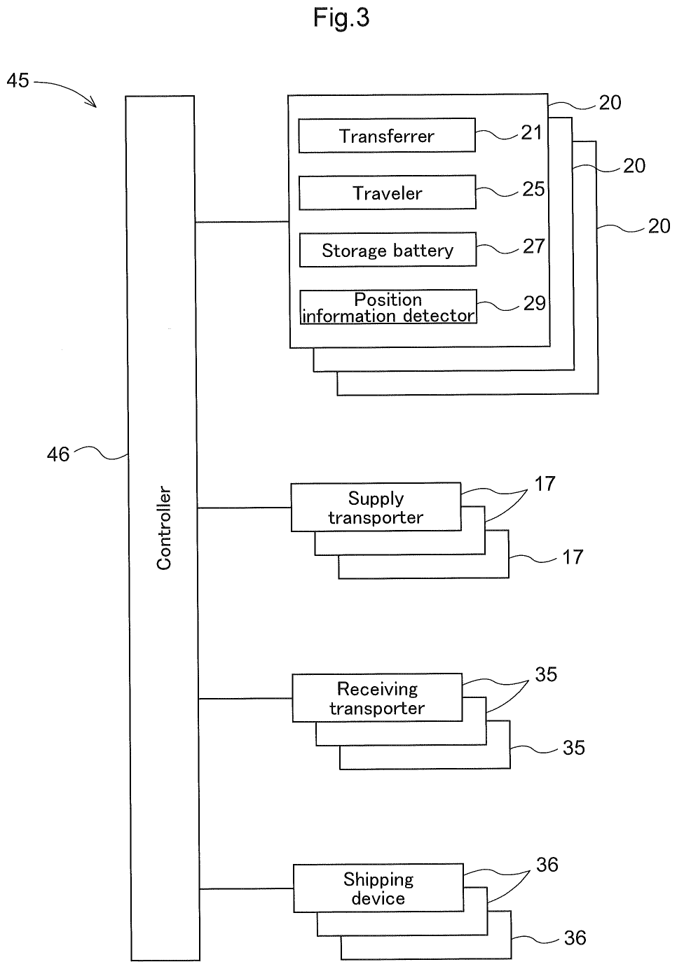

FIG. 2 is a front view of an aisle area E3. The aisle area E3 has the two ends in the X-direction along which multiple receivers 31 are arranged in the Y-direction. Each transport vehicle 20 includes a transferrer 21 that transfers an article W from the transport vehicle 20 to a receiver 31. The transferrer 21 has a receiving surface 22 on which the article W is placeable. The receiving surface 22 is switchable between a horizontal orientation and a tilting orientation. While being transported, the article W is placed on the receiving surface 22 in the horizontal orientation. When the receiving surface 22 is in the tilting orientation, the article W is transferred to the receiver 31. Each transport vehicle 20 includes a traveler 25. The traveler 25 includes multiple wheels 23 that roll on the travel surface on the floor E. Examples of the transport vehicles 20 include electric vehicles that travel on electricity supplied from storage batteries or fuel cells, or through contact or contactless power feed from the floor E and include vehicles with internal combustion engines. In the present embodiment, the traveler 25 in each transport vehicle 20 incorporates a storage battery 27 (refer to FIG. 3). In the present embodiment, the transport vehicles 20 are electric automatic guided vehicles.

Each of the multiple receivers 31 includes a receiving transporter 35. Articles W transferred to the receivers 31 are transported in the X-direction by the receiving transporters 35 to be placed in containers 38 for the respective receivers 31. The receiving transporters 35 are adjacent to shipping devices 36. The containers 38 are arranged on the shipping devices 36. When articles W of a type and in a quantity specified in one piece of order information are placed in a container 38, the corresponding shipping device 36 transports the container 38 to a shipping location. Examples of the receiving transporters 35 include belt conveyors, cranes, and robotic arms. Examples of the shipping devices 36 include belt conveyors, stacker cranes, and automatic guided vehicles.

FIG. 3 is a control block diagram of the article sorting facility 10 according to the present embodiment. The article sorting facility 10 includes a control system 45 that controls the transport vehicles 20. In the example in the figure, the control system 45 includes a controller 46 that controls the transferrer 21 and the traveler 25 in each transport vehicle 20, the supply transporters 17, the receiving transporters 35, and the shipping devices 36. The controller 46 includes an arithmetic processor such as a central processing unit (CPU) and a main storage such as a random-access memory (RAM) or a read-only memory (ROM) that can be referenced by the arithmetic processor. The functions of the controller 46 (e.g., the function of controlling the travel of the transport vehicles 20) are implemented by the hardware in the controller 46 cooperating with a program executed on the arithmetic processor or other pieces of hardware. More specifically, each function of the controller 46 is implemented by the controller 46 executing a program stored in a storage (e.g., the main storage or a storage separate from the main storage). In other words, the program (e.g., an article transport program) for causing a computer (a computer in the control system 45) to implement the functions of the controller 46 is stored in a storage that can be referenced by the computer. The program is provided by, for example, a storage medium or through a communication network. The provided program is then stored into the storage that can be referenced by the computer. In the present embodiment, the controller 46 (more specifically, the arithmetic processor in the controller 46) functions as the computer. The controller 46 may be a set of multiple pieces of hardware (multiple separate pieces of hardware) that can communicate with one another through wires or wirelessly, rather than a single piece of hardware. For example, the controller 46 may include a host controller disposed in a control facility (not shown) to control the transport vehicles 20 and controllers mounted on the respective transport vehicles 20.

The floor E is divided into multiple virtual subareas Au in a grid as viewed in the Z-direction. Travel paths for the transport vehicles 20 connect any number of virtual subareas Au to one another. In the present embodiment, each transport vehicle 20 includes a position information detector 29 (refer to FIG. 3). Each virtual subarea Au includes a position information holder. When the transport vehicles 20 travel on the travel paths, the position information detector 29 in each transport vehicle 20 detects position information held by the position information holder in each virtual subarea Au. Examples of the position information holder include a barcode (one-dimensional code), a two-dimensional code, and a radio-frequency identification tag. The position information detected by the position information detector 29 is transmitted from each transport vehicle 20 to the controller 46 in the control system 45.

The control system 45 provides, for example, a transport command to each transport vehicle 20. The transport command specifies the source and the destination of an article W. In the present embodiment, the source is one of the supply units 15. In the present embodiment, the destination is one of the receivers 31. The transport command specifies the travel path for the transport vehicle 20 to travel from the source to the destination. Upon receiving the transport command from the control system 45, the transport vehicle 20 receives an article W at the specified source and transports the article W to the specified destination.

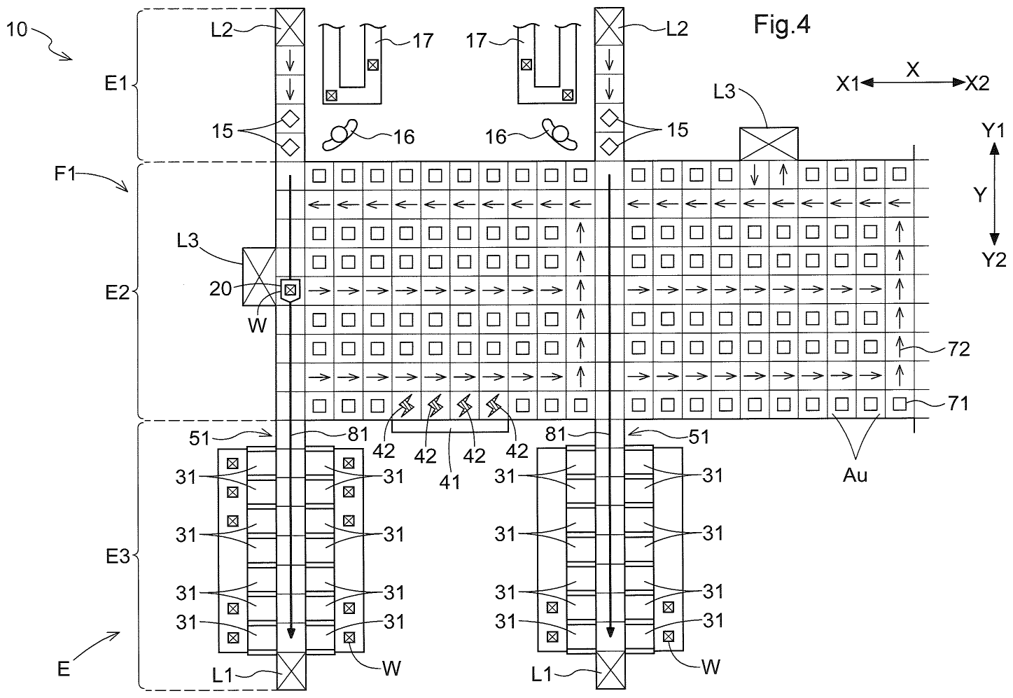

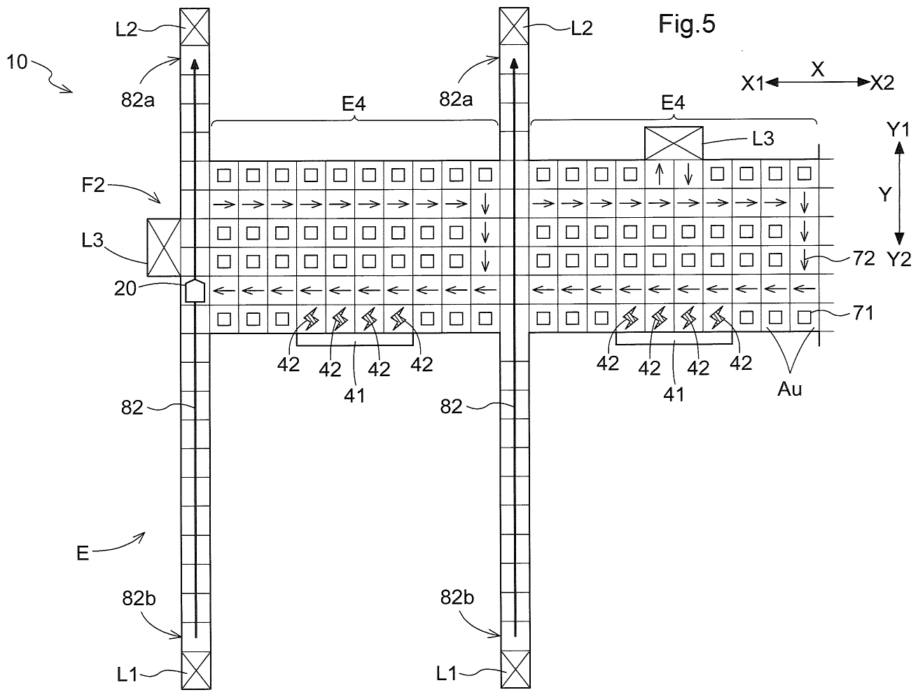

The transport command in the present embodiment defines an outgoing path 81 (refer to FIG. 4) for a transport vehicle 20 to travel from one of the supply units 15 to a terminal end of one of the aisle areas E3. The transport command in the present embodiment defines a return path for the transport vehicle 20 to travel from the terminal end of the aisle area E3 to one of the supply units 15. In the present embodiment, the return path is one of return aisles 82 (refer to FIG. 5) described later. In the present embodiment, the terminal end of the aisle area E3 is an end of the aisle area E3 on the second side Y2 in the Y-direction.

FIG. 4 is a diagram of a first layer F1 in the article sorting facility 10. The connection area E2 includes charging positions 42 for charging the transport vehicles 20 with a charger 41. This allows efficient use of the connection area E2, which includes no supply unit 15 and no receiver 31. In the example in the figure, the charger 41 is disposed adjacent to the connection area E2. The charging positions 42 are arranged to allow multiple transport vehicles 20 to stop at the charging positions 42.

Each transport vehicle 20 moves to and stops at a charging position 42 when the remaining battery level is less than a predetermined level (e.g., less than 50% of the full capacity). At the charging position 42, the storage battery 27 (refer to FIG. 3) in the transport vehicle 20 can be charged rapidly. The charger 41 may be a contactless power feeder or a contact power feeder. In the present embodiment, the controller 46 included in the control system 45 (described later) obtains the remaining level of the storage battery 27 in each transport vehicle 20 and controls any transport vehicle 20 with less than a predetermined battery level to move to the charging position 42.

FIG. 5 is a diagram of a second layer F2 in the article sorting facility 10. The floor E includes the first layer F1 and the second layer F2 at different levels in the Z-direction (vertical direction). The first layer F1 and the second layer F2 are adjacent to each other in the Z-direction. Although the second layer F2 is disposed above the first layer F1 in the present embodiment, the second layer F2 may be below the first layer F1. In the present embodiment, the first layer F1 includes the supply areas E1 and the aisle areas E3. In the present embodiment, the first layer F1 includes the connection area E2.

The article sorting facility 10 includes first lifters L1 that transport the transport vehicles 20 in the Z-direction. The first lifters L1 are connected to the aisle areas E3 in the first layer F1 and to the second layer F2. The article sorting facility 10 includes second lifters L2 that transport the transport vehicles 20 in the Z-direction. In the example in the figures, the second lifters L2 are connected to the supply areas E1 in the first layer F1 and to the second layer F2. The first lifters L1 and the second lifters L2 are spaced from each other in the horizontal direction.

The first lifters L1 and the second lifters L2 are connected by the return aisles 82 (described later) on the second layer F2 to allow the transport vehicles 20 to travel. In the example in the figures, the second lifters L2 are connected to the return aisles 82 and to the first layer F1. The first lifters L1 and the second lifters L2 may be directly or indirectly connected to the return aisles 82. The first lifters L1 may be directly or indirectly connected to the aisle areas E3. The second lifters L2 may be directly or indirectly connected to the supply areas E1. The first lifters L1 and the second lifters L2 may each autonomously transport the transport vehicles 20 or may each be controlled by the control system 45. Examples of the first lifters L1 and the second lifters L2 include devices that circulate multiple lifting tables along a predetermined annular path to lift and lower the transport vehicles 20, multicopters that can transport the transport vehicles 20, and elevators.

The second layer F2 includes the return aisles 82 on which the transport vehicles 20 travel. The first lifters L1 are connected to starting ends 82b of the return aisles 82 and to the terminal ends of the aisle areas E3. The second lifters L2 are connected to terminal ends 82a of the return aisles 82 and to the supply areas E1. In the example in the figure, the multiple return aisles 82 are arranged on the second layer F2 and each extend in the Y-direction. After transporting the articles W to the receivers 31 in the aisle areas E3, the transport vehicles 20 travel on the return aisles 82. In the present embodiment, the transport vehicles 20 are not allowed to wait on the return aisles 82. In the example in the figure, the return aisles 82 are one-way.

The second layer F2 includes aisle connection areas E4 to allow the transport vehicles 20 to travel between the multiple return aisles 82. In the example in the figure, each aisle connection area E4 is disposed between return aisles 82 adjacent to the aisle connection area E4 in the X-direction. The aisle connection areas E4 include the charging positions 42 for charging the transport vehicles 20. The aisle connection areas E4 include standby areas 71 (described later). The aisle connection areas E4 include travelable areas 72 (described later). A third lifter L3 (described later) is adjacent to and connected to each aisle connection area E4 to allow the transport vehicles 20 to travel from the corresponding aisle connection area E4 to the third lifter L3.

The floor E includes, in an area other than the aisle areas E3, the standby areas 71 for the transport vehicles 20 to wait in the standby areas 71 before entering the aisle areas E3. The floor E includes the travelable areas 72 in which the transport vehicles 20 are not allowed to wait. In the example in the figures, the virtual subareas Au with a square are the standby areas 71, and the virtual subareas Au with an arrow are the travelable areas 72. Although multiple transport vehicles 20 may wait in one standby area 71, one transport vehicle 20 waits in one standby area 71 in the present embodiment. The travelable areas 72 are one-way. The standby areas 71 and the travelable areas 72 may be changeable by the control system 45 or the operator, or may not be changeable. Although transport vehicles 20 are stopped in all the standby areas 71 in the example described below, transport vehicles 20 may not be stopped in some of the standby areas 71.

The second layer F2 includes the standby areas 71. The standby areas 71 on the second layer F2 are directly or indirectly connected to the return aisles 82. In the examples in the figure, the standby areas 71 on the second layer F2 are connected to the return aisles 82 with the travelable areas 72 between them. In the present embodiment, the connection area E2 on the first layer F1 also includes the standby areas 71.

The article sorting facility 10 further includes the third lifters L3 that transport the transport vehicles 20 in the vertical direction (Z-direction). The third lifters L3 are connected to the standby areas 71 on the second layer F2 and to the connection area E2 on the first layer F1. In the example in the figures, the transport vehicles 20 to wait in the standby areas 71 on the second layer F2 are transported to the second layer F2 by the third lifters L3. The transport vehicles 20 traveling from the standby areas 71 on the second layer F2 to the aisle areas E3 are transported to the first layer F1 by the third lifters L3, but may be transported to the first layer F1 by the second lifters L2. The third lifters L3 may be directly or indirectly connected to the standby areas 71 and the connection area E2. The first lifters L1, the second lifters L2, and the third lifters L3 may each autonomously transport the transport vehicles 20 or may each be controlled by the control system 45.

The third lifters L3 connect the standby areas 71 and the connection area E2. The first lifters L1 connect the terminal ends of the aisle areas E3 and the second layer F2. The second layer F2 includes the return aisles 82 on which the transport vehicles 20 travel. The second lifters L2 connect the terminal ends 82a of the return aisles 82 and the first layer F1. In the example in the figures, the second lifters L2 connect the terminal ends 82a of the return aisles 82 and the supply areas E1.

The standby areas 71 are arranged in multiple lines. The travelable areas 72 on which the transport vehicles 20 can travel are arranged between adjacent lines of the standby areas 71. All the standby areas 71 in each line are adjacent to at least one of the travelable areas 72.

The standby areas 71 and the travelable areas 72 are arranged to allow a transport vehicle 20 that receives an article W at a supply unit 15 to transport the article W to any of the multiple receivers 31. The standby areas 71 and the travelable areas 72 are arranged to allow the transport vehicle 20 that has transported the article W to a receiver 31 in an aisle area E3 to return to the supply unit 15.

In response to any of the receivers 31 being in a non-receiving state in which the receiver 31 cannot receive any article W, the control system 45 performs a first standby process to cause all the transport vehicles 20 for which the receiver 31 in the non-receiving state is the destination of the articles W to wait in the standby areas 71.

The control system 45 performs, at each receiver 31, a batch process of receiving articles W of a type and in a quantity specified in one piece of order information. In the present embodiment, one container 38 is used for one piece of order information. The control system 45 places the articles W of the type and in the quantity specified in one piece of order information in the batch process into a container 38 (refer to FIG. 2) adjacent to the receiver 31. When the batch process is complete, or in other words, when all the articles W of the type and in the quantity specified in one piece of order information is placed in the container 38, the container 38 is transported to the shipping location. Another container 38 corresponding to a subsequent piece of order information is then placed adjacent to the receiver 31. The control system 45 performs a subsequent batch process and places the articles W of the type and in the quantity specified in the subsequent piece of order information into the other container 38.

The control system 45 performs, at each receiver 31, a first batch process of receiving articles W of a type and in a quantity specified in one piece of order information, and then performs a second batch process of receiving articles W of a type and in a quantity specified in another piece of order information. In response to any of the receivers 31 being in an incomplete state in which the first batch process is not complete, the control system 45 performs a second standby process of causing all the transport vehicles 20 transporting the articles W to the receiver 31 in the incomplete state for the second batch process to wait in the standby areas 71.

The second batch process may be a subsequent batch process of the first batch process at a receiver 31 or may be a batch process after the subsequent batch process at the receiver 31. For example, in the second standby process, the control system 45 may cause all the transport vehicles 20 transporting articles W to the receiver 31 in the incomplete state for the batch process after the subsequent batch process of the first batch process and all the remaining batch processes to wait in the standby areas 71. For example, in response to the number of transport vehicles 20 transporting articles W for the first batch process or the number of transport vehicles 20 transporting articles W for the subsequent batch process of the first batch process being less than or equal to a predetermined number, the control system 45 may permit, in the second standby process, entry of the transport vehicles 20 transporting the articles W for the first batch process and the transport vehicles 20 transporting the articles W for the subsequent batch process of the first batch process into the aisle areas E3.

In response to the incomplete state of the receiver 31 being removed, the control system 45 causes the transport vehicle 20 transporting, for the second batch process, an article W to the receiver 31 with the incomplete state being removed to travel from the standby area 71 to the receiver 31. The control system 45 may cause transport vehicles 20 to wait for multiple different batch processes in the second standby process. In this case, the control system 45 causes transport vehicles 20 in the standby areas 71 transporting articles W for a batch process closer to the first batch process to travel to the receiver 31.

An article sorting facility 10 according to a second embodiment will be described below with reference to the drawings. In the present embodiment, the floor E on which the multiple transport vehicles 20 travel includes a single layer unlike in the first embodiment. The article sorting facility 10 according to the present embodiment will be described below focusing on the differences from the article sorting facility 10 according to the first embodiment. The components not described below are the same as those in the first embodiment.

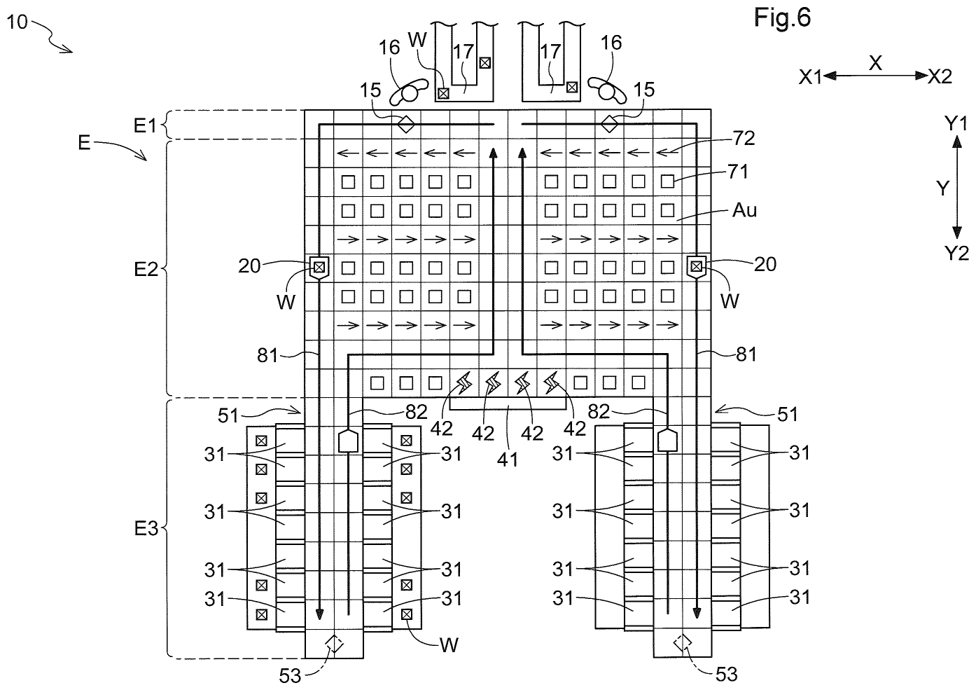

FIGS. 5 and 6 are top views of the article sorting facility 10 according to the present embodiment. FIG. 5 is a front view of an aisle area E3 in the present embodiment. In the present embodiment, the article sorting facility 10 includes turn positions 53 on the second side Y2 in the Y-direction relative to the first ends 51. In the example in the figures, the turn positions 53 are at the terminal ends of the aisle areas E3. The terminal ends of the aisle areas E3 are the ends of the aisle areas E3 on the second side Y2 in the Y-direction.

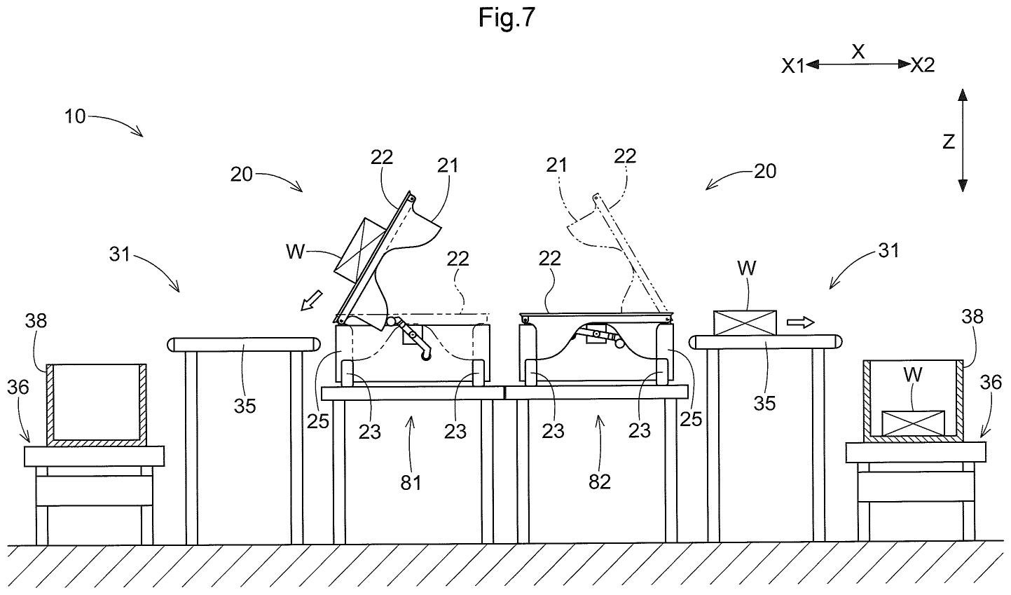

In the present embodiment, the outgoing path 81 is defined by the transport command to cause each transport vehicle 20 to travel from the first end 51 to the turn position 53 in each aisle area E3. The return path (return aisle 82) is defined by the transport command to cause the transport vehicle 20 that has U-turned at the turn position 53 to travel from the turn position 53 to the first end 51 in the aisle area E3. The outgoing path 81 and the return path (return aisle 82) are arranged adjacent to each other in the X-direction in each aisle area E3. In the present embodiment, as shown in FIGS. 6 and 7, the transport vehicles 20 transfer, on the outgoing path 81, the articles W to the receivers 31 disposed opposite to the return path (return aisle 82) in the X-direction in each aisle area E3, and transfer, on the return path (return aisle 82), the articles W to the receivers 31 disposed opposite to the outgoing path 81 in the X-direction in each aisle area E3.

An article sorting facility 10 according to other embodiments will now be described.

(1) In the first and second embodiments, the article sorting facility 10 includes the multiple supply areas E1, the connection area E2, and the multiple aisle areas E3 on the floor E. However, the structure is not limited to such an example. For example, the multiple aisle areas E3 may be replaced with a single aisle area E3. For example, the multiple supply areas E1 may be replaced with a single supply area E1. For example, the multiple supply units 15 may be replaced with a single supply unit 15.

(2) In the first and second embodiments, the supply areas E1 and the connection area E2 are separated by a virtual boundary, and each aisle area E3 has the two ends in the X-direction that are the outer edges of the floor E. However, the structure is not limited to such an example. For example, the supply areas E1, the connection area E2, and the aisle areas E3 may be defined by the actual outer edges of the floor E and may each be an area in which the transport vehicles 20 are movable. For example, the supply areas E1, the connection area E2, and the aisle areas E3 may all be virtually-defined areas on the large floor E. For example, the floor E may include areas different from the supply areas E1, the connection area E2, and the aisle areas E3, such as buffer areas in which multiple transport vehicles 20 can be in line.

(3) In the first and second embodiments, the control system 45 includes the host controller that controls the multiple transport vehicles 20 and the controllers mounted on the respective transport vehicles 20. However, the structure is not limited to such an example. For example, the control system 45 may be a system in which the controller on each transport vehicle 20 communicates with the controller on another transport vehicle 20 to autonomously determine the operation. For example, the floor E may include no position information holder. Position information about the transport vehicles 20 may be obtained by, for example, image sensors installed in the transport vehicles 20 or the facility.

(4) In the first and second embodiments, the control system 45 controls the transferrer 21 and the traveler 25 in each transport vehicle 20. However, the structure is not limited to such an example. For example, the controller 46 may control only the traveler 25 in each transport vehicle 20. For example, each transport vehicle 20 may not include the transferrer 21, and the operating entity 16 may transfer the article W on the transport vehicle 20. For example, the article W may be stored in a compartment included in the transport vehicle 20. For example, the control system 45 may control an operation device, which is the operating entity 16.

(5) In first and second embodiments, the control system 45 performs the first standby process and the second standby process. However, the structure is not limited to such an example. For example, the control system 45 may not perform the first standby process or the second standby process. For example, the control system 45 may perform neither the first batch process nor the second batch process, and the operator may specify a receiver 31 for each transport vehicle 20.

(6) In the first and second embodiments, in response to the incomplete state of the receiver 31 being removed, the control system 45 causes transport vehicles 20 to travel to the receiver 31. However, the structure is not limited to such an example. For example, before the incomplete state of the receiver 31 being removed, the control system 45 may cause transport vehicles 20 to travel to the receiver 31. For example, the control system 45 may cause transport vehicles 20 that has waited in the standby areas 71 for a predetermined time period to travel to the receiver 31.

(7) In the first and second embodiments, the article sorting facility 10 includes the supply transporters 17, the receiving transporters 35, and the shipping devices 36. However, the structure is not limited to such an example. For example, the article sorting facility 10 may not include the supply transporters 17, the receiving transporters 35, or the shipping devices 36. An operator or a vehicle operated by the operator may transport the articles W or the containers 38.

(8) In the first and second embodiments, the connection area E2 includes the charging positions 42 for charging the transport vehicles 20 with the charger 41. However, the structure is not limited to such an example. For example, the charging positions 42 may be arranged in other areas accessible to the supply areas E1, the aisle areas E3, and the connection area E2.

(9) In the first embodiment, the third lifters L3 are arranged adjacent to the return aisles 82. However, the structure is not limited to such an example. For example, each return aisle 82 may include a branch and a junction, and the corresponding third lifter L3 may be disposed between the branch and the junction. For example, the third lifters L3 may be arranged adjacent to the standby areas 71. For example, the article sorting facility 10 may not include the third lifters L3.

(10) In the first and second embodiments, the connection area E2 on the first layer F1 includes the standby areas 71. However, the structure is not limited to such an example. For example, the supply areas E1 may include the standby areas 71. For example, another area on the floor E connected to the supply areas E1 or the connection area E2 may include the standby areas 71. For example, only the second layer F2 may include the standby areas 71.

(11) The structure described in each of the above embodiments may be combined with any other structures described in the other embodiments unless any contradiction arises. The embodiments described herein are merely illustrative in all aspects and may be modified variously as appropriate without departing from the spirit and scope of the disclosure.

The article sorting facility according to one or more embodiments of the disclosure will be described below.

In one aspect, an article sorting facility is an article sorting facility in which a plurality of transport vehicles travel on a floor and transport articles to sort the articles. The article sorting facility includes supply units that supply the articles to the plurality of transport vehicles, and a plurality of receivers that receive the articles from the plurality of transport vehicles. The floor includes an aisle area along the floor, a supply area including the supply units, and a connection area connecting the aisle area to the supply area. The plurality of receivers are arranged along the aisle area. The floor includes, in an area other than the aisle area, a standby area for the plurality of transport vehicles to wait before entering the aisle area.

This structure allows a transport vehicle to wait in the standby area without causing the transport vehicle to enter the aisle area in response to a receiver that is a destination of an article transported by the transport vehicle being in the non-receiving state in which the articles are unreceivable by the receiver. This reduces the likelihood that the aisle area is congested with transport vehicles waiting in the aisle area, which is a narrow area extending in the specific direction. This also reduces the likelihood that the transport vehicles are to travel on the aisle area multiple times while passing by receivers in the non-receiving state to avoid congestion in the aisle area. As described above, this structure reduces the likelihood of congestion with the transport vehicles.

In one aspect, the article sorting facility further includes a control system that controls the plurality of transport vehicles. In response to a receiver of the plurality of receivers being in a non-receiving state, in which the articles are unreceivable by the receiver, the control system performs a first standby process of causing, among the plurality of transport vehicles, all of one or more transport vehicles transporting articles to the receiver in the non-receiving state to wait in the standby area.

In this structure, in response to any of the receivers being in the non-receiving state, all the transport vehicles for which the receiver in the non-receiving state is the destination of the articles can wait in the standby area. Thus, when some of the receivers are in the non-receiving state, the supply units are not to stop supplying the articles to the transport vehicles and can continue to supply the articles to the transport vehicles. This also reduces the likelihood that the aisle area is congested with the transport vehicles. The sorting efficiency of the article sorting facility is thus more likely to increase.

In one aspect, the article sorting facility further includes a control system that controls the plurality of transport vehicles. The control system performs, at each of the plurality of receivers, a first batch process of receiving, among the articles, an article of a type and in a quantity each specified in a piece of order information, and then performs a second batch process of receiving, among the articles, an article of a type and in a quantity each specified in another piece of order information. In response to a receiver of the plurality of receivers being in an incomplete state, in which the first batch process is not complete, the control system performs a second standby process of causing, among the plurality of transport vehicles, all of one or more transport vehicles transporting articles to the receiver in the incomplete state for the second batch process to wait in the standby area.

This structure allows the batch processes to be performed at the multiple receivers and reduces the likelihood that the aisle area is congested with transport vehicles waiting in the aisle area due to the batch processes. The sorting efficiency of the article sorting facility is thus more likely to increase.

In one aspect, in response to the incomplete state of the receiver being removed, the control system causes the one or more transport vehicles transporting, for the second batch process, the articles to the receiver with the incomplete state being removed to travel from the standby area to the receiver.

This structure causes, when a receiver enters a state in which the receiver can receive an article, transport vehicles to travel from the standby area to the receiver to transport articles. Compared with when the transport vehicles travel on the aisle area multiple times while passing by receivers in the non-receiving state, the transport vehicles travel by shorter distances, thus reducing energy and extra time taken for the transport vehicles to travel.

In one aspect, the article sorting facility further includes a first lifter and a second lifter that each transport the plurality of transport vehicles in a vertical direction. The floor includes a first layer and a second layer at respective levels different in the vertical direction. The first layer includes the aisle area and the supply area. The second layer includes a return aisle on which the plurality of transport vehicles travel. The first lifter connects a terminal end of the aisle area to the second layer. The second lifter connects a terminal end of the return aisle to the first layer. The standby area is included in the second layer.

This structure includes a large space for the paths for the transport vehicles that receive the articles and transport the articles to the receivers, and also includes the standby area.

In one aspect, the article sorting facility further includes a third lifter that transports the plurality of transport vehicles in the vertical direction. The first layer includes the connection area. The second lifter connects the terminal end of the return aisle to the supply area. The third lifter connects the standby area to the connection area.

This structure allows transport vehicles waiting in the standby area on the second layer to travel promptly to the connection area using the third lifter without causing the transport vehicles to travel through the supply units again.

The article sorting facility according to one or more embodiments of the disclosure may produce at least one of the above advantageous effects. The technical features of the article sorting facility according to one or more embodiments of the disclosure are applicable to an article sorting method and an article sorting program.

What is claimed is:

1. An article sorting facility wherein a plurality of transport vehicles travel on a floor and transport articles to sort the articles, the article sorting facility comprising:
supply units configured to supply the articles to the plurality of transport vehicles; and
a plurality of receivers configured to receive the articles from the plurality of transport vehicles,
wherein:
the floor comprises:
an aisle area along the floor;
a supply area including the supply units; and
a connection area connecting the aisle area to the supply area,
the plurality of receivers is arranged along the aisle area,
the floor comprises, in an area other than the aisle area, a standby area for the plurality of transport vehicles to wait before entering the aisle area.

2. The article sorting facility according to claim 1, further comprising:
a control system configured to control the plurality of transport vehicles, and
wherein in response to a receiver of the plurality of receivers being in a non-receiving state in which the articles are unreceivable by the receiver, the control system performs a first standby process of causing, among the plurality of transport vehicles, all of one or more transport vehicles transporting articles to the receiver in the non-receiving state to wait in the standby area.

3. The article sorting facility according to claim 1, further comprising:
a control system configured to control the plurality of transport vehicles,
wherein the control system performs, at each of the plurality of receivers, a first batch process of receiving, among the articles, an article of a type and in a quantity each specified in a piece of order information, and then performs a second batch process of receiving, among the articles, an article of a type and in a quantity each specified in another piece of order information, and
wherein in response to a receiver of the plurality of receivers being in an incomplete state in which the first batch process is not complete, the control system performs a second standby process of causing, among the plurality of transport vehicles, all of one or more transport vehicles transporting articles to the receiver in the incomplete state for the second batch process to wait in the standby area.

4. The article sorting facility according to claim 3, wherein:
in response to the incomplete state of the receiver being removed, the control system causes the one or more transport vehicles transporting, for the second batch process, the articles to the receiver with the incomplete state being removed to travel from the standby area to the receiver.

5. The article sorting facility according to claim 1, further comprising:
a first lifter and a second lifter each configured to transport the plurality of transport vehicles in a vertical direction, and
wherein:
the floor comprises a first layer and a second layer at respective levels different in the vertical direction,
the first layer includes the aisle area and the supply area,
the second layer comprises a return aisle on which the plurality of transport vehicles travel,
the first lifter connects a terminal end of the aisle area to the second layer,
the second lifter connects a terminal end of the return aisle to the first layer, and
the standby area is included in the second layer.

6. The article sorting facility according to claim 5, further comprising:
a third lifter configured to transport the plurality of transport vehicles in the vertical direction, and
wherein:
the first layer includes the connection area,
the second lifter connects the terminal end of the return aisle to the supply area, and
the third lifter connects the standby area to the connection area.
